(19) United States
(12) Patent Application Publication
(10) Pub. No.: US 2011/0173249 A1
(43) Pub. Date: Jul. 14, 2011

(54) SYSTEMS AND METHODS FOR MONITORING AND TRACKING BROADCAST SERVICE POINT USAGE

(75) Inventors: JANGWON LEE, San Diego, CA (US); Samir S. Soliman, San Diego, CA (US)

(73) Assignee: QUALCOMM Incorporated, San Diego, CA (US)

(21) Appl. No.: 12/686,664

(22) Filed: Jan. 13, 2010

(51) Int. Cl. G06F 15/16; G06F 15/173

(52) U.S. Cl. 709/203; 709/224; 709/226

(57) ABSTRACT

Systems and methods are described for providing content using distributed broadcast access points that include wide area broadcast interfaces for receiving content and local and/or personal area network interfaces for communicating content to client devices. In an embodiment, a system transmits usage logging notifications to one or more broadcast access points. The broadcast access points log usage data regarding the usage of the broadcast access points by client devices and/or content accessed via the broadcast access points. The logged data is then optionally used to customize one or more channels of content. Different broadcast access points may have access to different channels of content. A given channel of content optionally includes content aggregated from a plurality of different sources.

### BACKGROUND

1. Field

The present invention is related to wireless communication systems, and in particular to systems and methods of managing and monitoring wireless communication systems.

2. Background

Wireless communication systems are widely deployed to provide various types of voice communication and data services. A typical wireless communication system can provide multiple users access to one or more shared resources, such as network bandwidth.

Wireless communication systems oftentimes employ one or more base stations that provide a coverage area by providing broadcast bandwidth within the coverage area. A typical base station can transmit and receive data streams and voice signals to and from one or more client devices, such as mobile phones.

However, typically such base stations use valuable broadcast bandwidth to communicate content to client devices. Further, the use of services provided via such base stations is not adequately tracked and analyzed.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Described herein are systems and methods for tracking and analyzing access point usage. By way of example, an access point can include a router function as well as broadcast interfaces/connectivity and/or local wireless network interfaces/connectivity such as PAN (personal area network)/LAN (Local Area Network) interfaces/connectivity. Such an access point is sometimes referred to herein as a broadcast access point (BAP).

In addition, described herein are systems and methods that enable various entities or end-users to become on-site broadcasters of content using BAP. Certain embodiments optionally statically and/or dynamically generate customized content and media guides for groups of BAPs, specific BAPs, groups of users, and/or individual users. The customized content is optionally selected using the tracking and usage information and/or BAP location information.

An embodiment of a localized broadcasting system comprises a first broadcast access point, the first broadcast access point including a processor, a wide area broadcast network interface coupled to the processor, a wireless local area network interface and/or wireless personal area network interface coupled to the processor, and a usage logging module. The a usage logging module is configured to receive a usage logging notification from a remote system, at least partly in response to the usage logging notification from the remote system, log usage data with respect to content provided by the first broadcast access point to one or more client devices that access content from the first broadcast access point via the wireless local area network interface and/or the wireless personal area network interface, and transmit usage information to the remote system, wherein the usage information includes at least a portion of and/or is derived from the usage data. The localized broadcasting system includes the remote system, wherein the remote system is configured to receive the usage information, wherein the usage information is to configured to be utilized to specify a customized content channel to be provided to at least one client device and/or a user thereof. The first broadcast access point is further configured to transmit a media guide via the wireless local area network and/or wireless personal area network interface to a first client device, wherein the media guide includes an identification of content provided via the customized content channel. The first broadcast access point is also configured to transmit content associated with the customized content channel to the first client device via the wireless local area network interface and/or wireless personal area network interface.

An embodiment of a computer program product comprises a computer-readable medium comprising code operable to cause a computer to transmit a usage logging notification to a first broadcast access point over a wide area broadcast network, the usage logging notification instructing the first broadcast access point to collect usage information related to the usage of the first broadcast access point by client devices and/or of content provided by the first broadcast access point to client devices, wherein the first broadcast access point is configured to provide the content to the client devices via a wireless local area network interface and/or wireless personal area network interface. The code operable to cause the computer to receive usage information from the first broadcast access point, the usage information related to the usage of the first broadcast access point by client devices and/or content provided by the first broadcast access point to client devices, and store a customized channel definition, the customized channel definition generated at least in part based on the received usage information.

An embodiment of a computer implemented method for distributing customized content, the method comprising transmitting a usage logging notification to a first broadcast access point over a wide area broadcast network, the usage logging notification instructing the first broadcast access point to collect usage information related to the usage of the first broadcast access point by client devices and/or of content provided by the first broadcast access point to client devices, wherein the first broadcast access point is configured to provide the content to the client devices via a wireless local area network interface and/or wireless personal area network interface. The method further comprises receiving usage information from the first broadcast access point, the usage information related to the usage of the first broadcast access point by client devices and/or content provided by the first broadcast access point to client devices and storing a customized channel definition, the customized channel definition generated at least in part based on the received usage information.

An embodiment of an apparatus for distributing content comprises means for transmitting a usage logging notification to a first broadcast access point over a wide area broadcast network, the usage logging notification instructing the first broadcast access point to collect usage information related to the usage of the first broadcast access point by client devices and/or of content provided by the first broadcast access point to client devices, wherein the first broadcast access point is configured to provide the content to the client devices via a wireless local area network interface and/or wireless personal area network interface. The embodiment further comprises means for receiving usage information from the first broadcast access point, the usage information related to the usage of the first broadcast access point by client devices and/or content provided by the first broadcast access point to client devices, and means for storing a customized channel definition, the customized channel definition generated at least in part based on the received usage information.

### BRIEF DESCRIPTION OF THE DRAWINGS

The disclosed aspects will hereinafter be described in conjunction with the appended drawings, provided to illustrate and not to limit the disclosed aspects, wherein like designations denote the elements.

FIG. 1 illustrates a first example usage tracking process and architecture.

FIG. 2 illustrates a second example usage tracking process and architecture.

FIG. 3 illustrates a third example usage tracking process and architecture.

FIG. 4 illustrates a fourth example usage tracking process and architecture.

FIG. 5 illustrates a fifth example usage tracking process and architecture.

FIG. 6 illustrates a sixth example usage tracking process and architecture.

FIG. 7 illustrates a seventh example usage tracking process and architecture.

FIG. 8 illustrates an eighth example usage tracking process and architecture.

FIG. 9 illustrates an example embodiment of local broadcasting using multiple BAPs.

FIG. 10 illustrates an example embodiment of a distributed local broadcasting system and architecture.

FIG. 11 illustrates an example content customization process.

FIG. 12 illustrates an example process for providing customized content.

### DETAILED DESCRIPTION

Described herein are example systems and methods that enable various entities or end-users to become on-site broadcasters of content, including but not limited to customized broadcasting, using broadcast access points. Also described herein are example systems and methods for tracking and analyzing access point usage. As will be described below, certain embodiments utilize the access point usage information to select customized channels of content, which are optionally transmitted to client devices over a PAN/LAN network using one or more broadcast access points.

The present devices, apparatus, methods, computer-readable media and processors now will be described more fully hereinafter with reference to the accompanying drawings, in which aspects of various embodiments are shown. The devices, apparatus, methods, computer-readable media and processors, however, may be embodied in many different forms and should not be construed as limited to the aspects set forth herein.

Various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, a computing device, an entertainment device (e.g., a television) or other audio/visual (AV) device having wireless connection capability, or other processing device connected to a wireless modem. Moreover, various embodiments are described herein in connection with an access point. An access point can be utilized for communicating with and transferring data to and from mobile device(s).

Various modes of usage tracking will now be discussed with respect to access points, such as access points that act as routers. Optionally, an access point may be in the form of a broadcast access point (BAP) including one or more broadcast ports providing wide area broadcast connectivity and also including one or more PAN/LAN ports providing PAN/LAN connectivity. Optionally, the PAN/LAN port transmits content using a non-addressed transmission where client devices can “tune in to” an ongoing transmission of content.

By way of illustration, the wide area broadcast connectivity can be compatible with cellular phone standards (e.g., UMTS, CDMA2000, TD-CDMA/TD-SCDMA, EDGE, UWC, DECT, Mobile WiMAX, LTE, UMB, other 3G networks, 4G networks, etc.) and/or other broadcast standards, such as MediaFlo, other multicasting forward link only technologies (where the data transmission path is one-way, such as from a network to the receiving device), T-DMB (Digital Media Broadcasting), ISDB-T (Integrated Services Digital Broadcasting—Terrestrial), 1seg, DVB-H ((Digital Video Broadcasting-Handheld)), tdTV, CMMB, OMA BCAST, WiMax, 3GPP Multimedia Broadcast Multicast Service (3GPP MBMS), etc.), and/or non-standard protocols and technologies.

By way of further example, the personal/local area network connectivity can be compatible with a variety of personal/local area network protocols, such as one or more IEEE 802.11 variants, Bluetooth, UWB (UltraWide Band), NFC, ZigBee, HiperLAN/2, etc. It is to be appreciated that the aforementioned listings of technologies and standards are provided as examples, and other past, current, or future, technologies (whether part of a standard or not), and standards can be used as well. The BAP may have an external antenna, to thereby provide an enhanced quality of service with respect to one or more parameters, such as coverage, error rate, latency, etc.

An example BAP can receive and transmit multimedia content. Multimedia content can include some or all of the following: real-time data (e.g., video, audio, tele-text, etc.), non-real-time data (e.g., pre-recorded clip casts which are downloaded for later viewing, pre-recorded audio clips, downloaded for later listening), and/or IP datacasts.

In a particular example embodiment, a wireless BAP is configured to distribute multimedia broadcasting content, such as television and/or radio audio channels (e.g., via MediaFlo, DMB, etc.), received from a broadcast transmitter, content from a local or remote mass storage device, or other source, by transmitting the content to multiple devices via PAN/LAN connectivity. Thus, even when devices, such as mobile phones or other client devices, do not have WAN (broadcasting) connectivity (e.g., as a result of poor reception or other absence of a WAN broadcast interface), nonetheless multiple devices can substantially simultaneously receive different (or the same) multimedia broadcast content via the same access point (e.g., a BAP).

Further, when a client device is connected to the BAP (e.g., to receive television channel or other content) using a short range radio link rather than via the broadcast link, the device power consumption will typically be reduced. The reduction of device power consumption is particularly beneficial for mobile devices having limited battery life.

Examples of devices with which an example access point communicates can include, but are not limited to cell phones, personal digital assistants, other handheld and/or mobile devices, automobile-installed devices (e.g., navigation systems, televisions, radios, etc.), entertainment devices (e.g., televisions), gaming consoles, etc. As noted above, the client devices may optionally include both broadcast WAN connectivity and PAN/LAN connectivity.

An example embodiment of a BAP includes a single tuner (e.g., a mobile television tuner) to support multiple channel acquisition. Optionally, the BAP may have multiple tuners (e.g., mobile television tuners) to support a higher number of channel acquisition. Optionally, rather than (or in addition to) using multiple tuners to access multiple channels, multiple multimedia broadcast services (e.g., multiple television channels) can be accessed via logical channels, such as multicast logical channels (MLCs), which are decoded by the BAP receiver.

The BAP may receive a media presentation guide (MPG) from a remote system via a broadcast port. The MPG may include a listing of available content channels (e.g., television channels, or other channels of available of content, such as movie channels, sports channels, music video channels, real time videos, other entertainment/news/educational channels, etc., where the content may be available on an on-demand basis, on a scheduled basis, and/or a hybrid of on-demand and scheduled content as discussed below) and optionally a broadcast schedule of shows including content program timing. Optionally, a single MPG can list content aggregated from multiple sources (e.g., broadcast television, Internet sites, local storage, remote servers, etc.). The BAP may transmit the media presentation guide a user client device. In addition, the BAP may transmit subscription information to the user device via a PAN/LAN port, providing some or all of the following: a listing of the services (e.g., channels or channel packages, such as a sports package, a movie package, a game package, a financial news service package, etc.) the user is currently subscribed to, the cost of the services (e.g., a monthly subscription fee), and additional services the user may subscribe to. Optionally, the BAP is configured to receive subscription requests from user devices, and process or forward for processing such subscription requests (e.g., to a broadcast service provider system, a BAP service provider system, or other system). Once a subscription request is processed and approved, the BAP may be used to provide the subscription service via a PAN/LAN port.

A BAP may be owned by (e.g., via outright ownership or via a license/lease from an outright owner), provided by, operated and/or maintained by a BAP service provider (BSP). The BSP may be a different entity then the broadcast provider providing cellular broadcast service.

As noted above, certain embodiments provide usage tracking with respect to broadcast services. The tracking may be with respect to the use of an access point to provide services to client devices and/or the tracking may be with respect to client devices, such as an “end-user” mobile device's service usage. The tracking may be performed using a client application resident and executing on a client device and/or using a logging application resident and executing on a BAP. For example, if MediaFlo is being utilized, a MediaFlo client may perform event logging.

In an example embodiment, one or more selected devices log user interactions with associated mobile television applications. Examples of such logged interactions may include some or all of the following events and/or other events:
subscribing to a service package (e.g., a broadcast service package including one or more channels of content);
unsubscribing from a service package;
channel selections (e.g., which channels are selected, when they are selected, and for how long);
viewing of real-time services;
viewing of downloaded content;
viewing dates/times;
link activations;
etc.

The collected usage data is communicated to and stored in memory accessible by a networked computer system, such as that associated with a broadcast service provider, a BAP service provider, and/or other entity. For example, the networked computer system optionally may be an operations system that provides some or all of the following: billing functions, content management services, receipt and storage of content from content providers, distribution of content and program media guide presentation information to user devices (optionally via an access point), user-service subscription management, delivery of access and encryption keys, etc. The collected usage data is accessed and used (e.g., by a computer program and/or a human) to perform some or all of the following and/or other tasks:
selecting targeted advertising to be provided via a selected set of access points (the set including one or more access points);
selecting targeted advertising to be provided via a selected set of user devices (the set including one or more selected user devices);
selecting which broadcast services (e.g., which channels) are to be provided;
selecting which broadcast services (e.g., which channels) are to be provided via a selected set of access points;
selecting which broadcast services (e.g., which channels) are to be provided to a selected set of user devices;
selecting which channels are to be included in a given subscription channel package (e.g., a sports channel package, a movie channel package, a comedy channel package, a music channel package, a weather channel package, a news channel package, a cooking channel package, a children channel package, a history channel package, an educational channel package, etc.);
determining if a given program and/or channel is to be blocked/blacked out for a specified time period and/or geographic area (e.g., a sporting event program);
determining whether additional access points are to be provided and if so, the location of such additional access points;
determining if and where additional broadcast bandwidth capacity is needed;

etc.

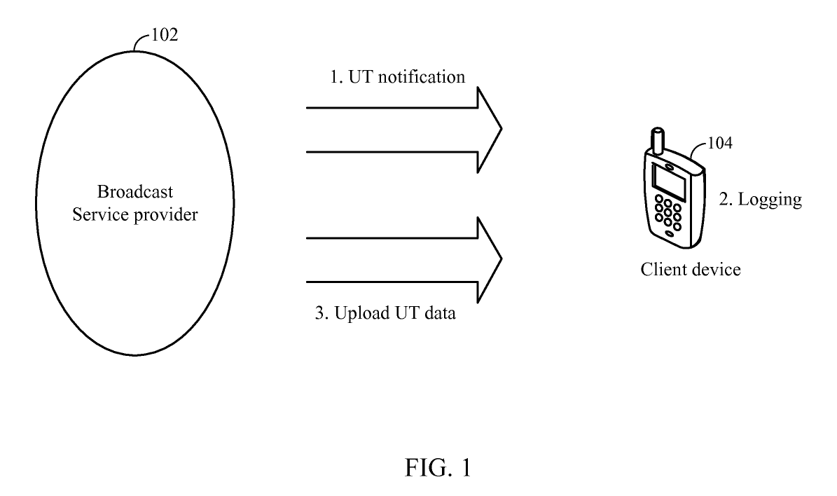

FIG. 1 illustrates an example usage tracking process where a BAP is not utilized as an intermediary with respect to communicating with a client device. At state 1, a broadcast service provider system transmits a usage tracking notification to all or selected client devices accessible by the system. By way of example, the notification may have been transmitted in response to a calendared notification instruction stored in memory (e.g., that instructs the system to transmit the notification periodically or a specific dates and times), in response to a manual operator instruction, and/or in response to one or more other detected events.

The logging notification may be transmitted to the client device(s) via a broadcast network and/or via a PAN/LAN. The client devices may include different types of devices (e.g., some may be dedicated wireless televisions and some may be phones including a television function) or may be of the same type.

This logging notification can provide some or all of the following information/instructions:
an identification of the devices that are to perform the logging function (e.g., via specific device identifiers, an identifier that identifies a group of devices, etc.);
an identification of the information that the device is to log (e.g., service package subscriptions, unsubscribing to service packages, channel selections, viewing of real-time services, viewing dates/times, and/or link activations);
an identification of a logging period (when should the logging begin and/or end);
an identification of the reporting trigger (e.g., when a logging report should be sent back, which may, for example, specify some or all of the following: reporting frequency, time of day to transmit the report, quantity of logged events, percent of device memory used, size of log file; connection to a BAP);
an identification as to which system/system type the logged data is to be transmitted to.

The foregoing identifications may in the form of a code, encrypted or otherwise.

Optionally, some or all of the usage tracking logging instructions may be preprogrammed into the client device. Optionally, a logging notification message may be used to update or override such preprogrammed logging instructions.

At state 2, the selected client device(s) begin logging usage tracking events/data as instructed and stores the logged data in client device memory.

At state 3, the client device uploads the usage tracking data to the broadcast service provider system in response to a request from the broadcast service provider system or in response to a reporting trigger.

Depending on which business entity (either broadcast service provider or BAP service provider) manages and maintains the usage tracking data, usage tracking service modes can be classified into the following categories: (1) broadcast service provider managed usage tracking service and (2) BAP service provider managed usage tracking service for BAPs. Other categories can be used as well. Further, a broadcast service provider may also be a BAP service provider.

With respect to a broadcast service provider managed usage tracking service, the broadcast service provider manages and/or owns the usage tracking service data for BAPs and client devices. This category has includes some or all of the following sub-modes: (1) usage tracking service for devices, (2) usage tracking service for BAPs, and (3) usage tracking service for both devices and BAPs.

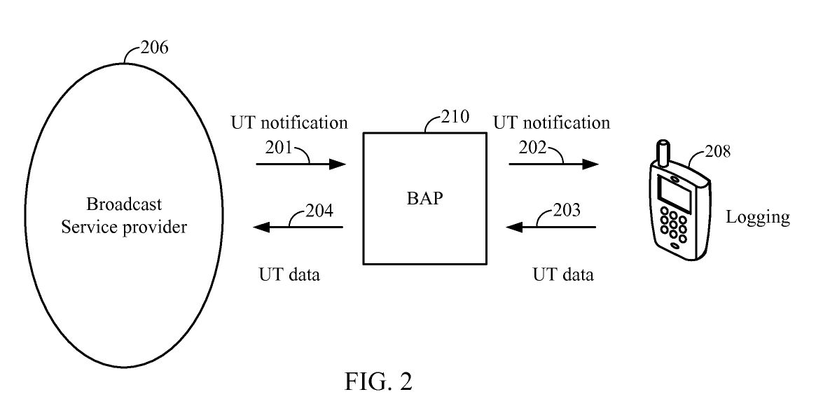

FIG. 2 illustrates an example usage tracking service process for client devices. In this example, at state 201 a broadcast service provider system 206 transmits a usage tracking notification to a BAP 210 or to multiple BAPs. The usage tracking notification may contain upload instructions for one or more BAPs and/or one or more client devices. At state 202, the BAP 210 forwards the usage tracking notification from the broadcast service provider 206 to a client device 208 hosting the logging application. At state 203, the client device 208 transmits the logged usage tracking data to the BAP 210 in response to a request from the broadcast service provider system/BAP or in response to a reporting trigger. At state 204, the BAP 210 transmits the usage tracking data to the broadcast service provider system 206. Optionally, the BAP 210 preprocesses the usage tracking data prior to transmitting the data to the broadcast service provider system 206. For example, the BAP 210 may tabulate or aggregate usage data from a plurality of client devices and/or perform a statistical analysis on the usage data prior to transmitting the tracking usage data to the broadcast service provider system 206.

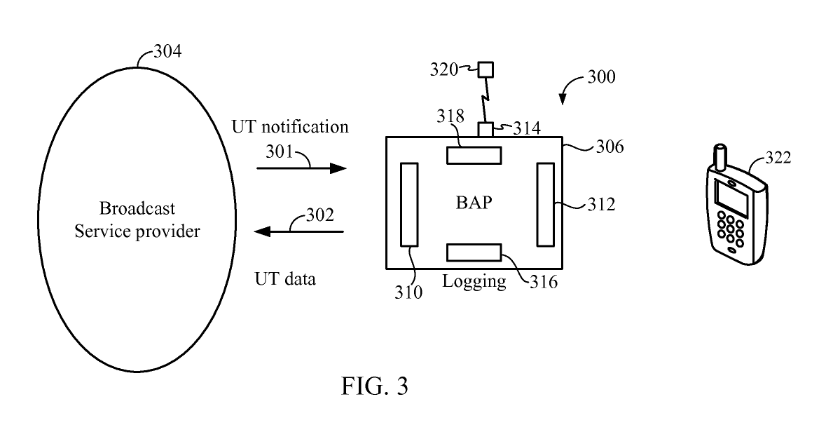

FIG. 3 illustrates an example usage tracking process with respect to BAPs. In the illustrated example, a BAP 306 includes a processor 316 and memory 318, including program memory, working memory, and memory used to store tracking data. The memory can include volatile and/or non volatile memory, and can optionally include solid state, magnetic, and/or optical storage devices.

The BAP 306 further includes a broadcast interface 310 to communicate via a broadcast network. In addition, the BAP 306 includes a PAN and/or LAN interface 312, which can be used to communicate with client devices 322. Optionally, the BAP 306 can communicate with client devices 322 via the broadcast network in addition to or instead of the broadcast network. Optionally, the BAP 306 can communicate directly with client devices 322 without ever using the broadcast network to thereby reduce the burden on the broadcast network and broadcast network bandwidth. Optionally, the BAP 306 includes a wired (e.g., Ethernet) or wireless network interface 314 to a remote content storage system 318. Optionally, the BAP 306 can communicate with the storage system 318 using the broadcast network and/or the PAN/LAN. Other BAPs described herein optionally have the same or similar configuration as BAP 306, or optionally have different configurations.

At state 301, the broadcast service provider system 304 transmits a usage tracking notification to one or more BAPs 306, requesting the BAPs 306 to log various usage tracking data, including tracking data related to access of the BAP by client devices 322. The tracking notification can specify the data to be logged or can specify a logging profile to be used, where the logging profile has previously been stored on the BAP 306. The usage tracking data may include some or all of the following events and/or other events:
how many client devices are accessing the BAP 306 over a time period (the time period may be specified by the notification or logging profile, or the notification may simply initiate event logging (where the logging may be immediately initiated in response to the notification or may be initiated at a later specified time), where the logging will continue until the BAP 306 receives a message to stop logging and/or until the BAP 306 has insufficient memory available to continue logging usage data);
how many client devices are accessing the BAP 306 at each point in time;
what is the average and/or median number of client devices accessing the BAP 306 over a specified time period;
what is the peak number of client devices accessing the BAP 306;
when are the peak number of client devices accessing the BAP 306;
what is the lowest number of client devices accessing the BAP 306 over a specified time period;
which channels client devices access;
when (e.g., the day/time) client devices are accessing a given channel;
ranking of channel popularity with respect to client accessing the channels at given time periods;
how long devices access the BAP 306 (e.g. a total over a given period and/or for a given access session);
the frequency of channel changes by client devices;
when (e.g., the day/time) channel changes occur;
the origin channel and destination channel for channel changes.

At state 300, the BAP 306 collects usage tracking information with respect to client devices 322 that are accessing or have accessed the BAP. The data collection can be performed with a specified start and end date or can be continuously performed until collection is manually halted. The data collection state 300 optionally can continue in parallel while other process states are taking place or can instead be paused or halted. The data collected can include some or all of the data discussed above and/or other data.

At state 302, the BAP 306 transmits the client device usage tracking logging data to the broadcast service provider system 304. For example, the usage tracking logging data can be transmitted via a broadcast network, a wired network, or other network to the broadcast service provider system 304.

Should there be privacy concerns with respect to usage tracking for client devices 322, optionally the BAP 306 is configured so that the BAP 306 will collect and/or retain only statistical information and will not forward any client specific usage tracking data. Optionally, a user interface is transmitted by the BAP, BSP system or otherwise to a user client device via which the user can opt out or into having the user's usage tracked. Optionally, to avoid disclosure of client specific usage tracking data, the BAP will delete any client specific usage tracking data from its internal memory once the statistical analysis on the data is performed so that it cannot later be accessed.

Optionally, in certain embodiments, the BAP 306 is configured to provide selected types of usage tracking data for a specific client device, but not in association with a client device or user identifier. Optionally, the BAP 306 is configured to provide selected types of usage tracking data for a specific client device in association with a client device or user identifier (e.g., for usage tracking information that does not raise significant privacy concerns).

In certain instances, a BAP 306 may be equipped with client functionality. For example, the BAP 306 may include both access point/router functionality that can be utilized by other client devices to access broadcast services, such as television channels, and end-user client device functionality, such as a user interface, a display, and a speaker to enable a user to select content channels, and view and hear content. For use cases where a BAP is equipped with client functionality, the broadcast service provider can request (1) usage tracking data only for the routing functionality, (2) usage tracking data for only client functionality or (3) usage tracking data for both routing and client functions.

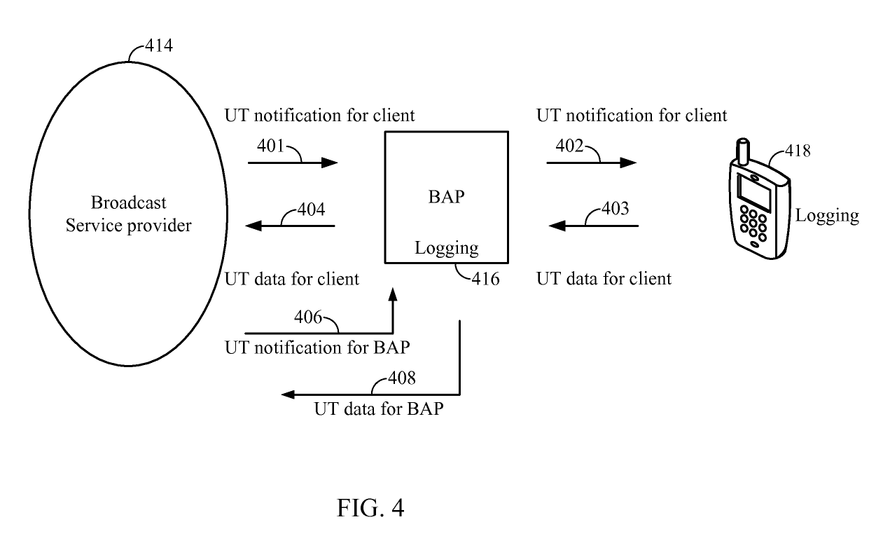

FIG. 4 illustrates an example broadcast service provider managed usage tracking process with respect to both client devices and BAPs. This mode can be considered as the combination of the previous two modes. The broadcast service provider system 414 can provide instructions for both the BAPs and client devices to collect various types of usage tracking data, optionally at substantially the same time. The broadcast service provider system 414 can likewise collect usage tracking data from the BAPs 416 and client devices 418.

At state 401, a broadcast service provider system 414 transmits a usage tracking notification to one or more BAPs 416. At state 402, the BAP 416 forwards the usage tracking notification from the broadcast service provider 414 to a client device 418 hosting the logging application. At state 403, the client device 418 transmits the logged usage tracking data to the BAP 416 in response to a request from the broadcast service provider system/BAP or in response to a reporting trigger. At state 404, the BAP 416 transmits the usage tracking data to the broadcast service provider system 414. Optionally, the BAP 416 preprocesses the usage tracking data prior to transmitting the data to the broadcast service provider system 414. For example, the BAP 416 may tabulate, aggregate, and/or statistically analyze usage data from a plurality of client devices prior to transmitting the tracking usage data to the broadcast service provider system 414.

At state 406, the broadcast service provider system 414 transmits a usage tracking notification to one or more BAPs 416, requesting the BAPs 416 to log various usage tracking. At state 408, the BAP 416 transmits the BAP usage tracking logging data to the broadcast service provider system 414. As discussed above, the logging data may be preprocessed by the BAP 416 and the privacy of the client devices can be maintained with respect to the usage tracking data.

A BAP service provider (BSP) may install one or more BAPs over a small, medium, or large geographic area. A BSP may have its own wired, broadcast, and/or PAN networks or infrastructure to support richer services to the client devices. The BSP can manage and own the usage tracking service data for its BAPs and for client devices provided by the BSP and/or for which the BSP provides services.

As with broadcast service provider managed usage tracking service, in the case of the BSP managed usage tracking service there may be several sub-modes, such as the following: (1) usage tracking service for devices, (2) usage tracking service for BAPs, and (3) usage tracking service for both devices and BAPs.

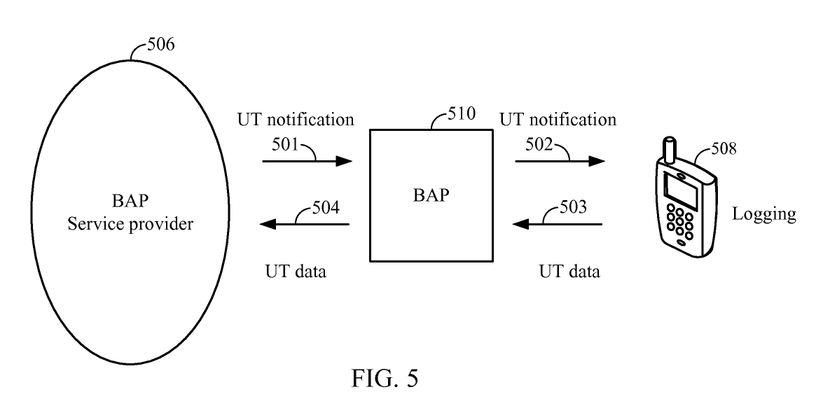

FIG. 5 illustrates an example usage tracking service process for client devices. In this example, at state 501 a BAP service provider system 506 transmits a usage tracking notification to a BAP 510. The usage tracking notification may contain upload instructions for one or more BAPs and/or one or more client devices. At state 502, the BAP 510 forwards the usage tracking notification from the BAP service provider system 506 to a client device 508 hosting the logging application. At state 503, the client device 508 transmits the logged usage tracking data to the BAP 510 in response to a request from the BAP service provider system/BAP or in response to a reporting trigger. At state 504, the BAP 510 transmits the usage tracking data to the BAP service provider system 506. Optionally, the BAP 510 preprocesses the usage tracking data prior to transmitting the data to the BAP service provider system 506. For example, the BAP 510 may tabulate, aggregate, and/or statistically analyze usage data from a plurality of client devices prior to transmitting the tracking usage data to the BAP service provider system 506.

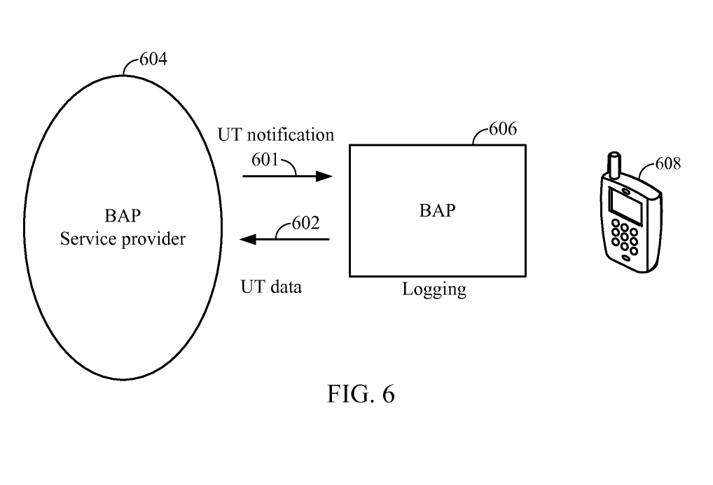

FIG. 6 illustrates an example usage tracking process with respect to BAPs. At state 601, the BAP service provider system 604 transmits a usage tracking notification to one or more BAPs 606, requesting the BAPs 606 to log various usage tracking. The usage tracking data may include some or all of the following events and/or other events:
how many client devices 608 are accessing the BAP over a time period (the time period may be specified by the notification or the notification may simply initiate event logging which will continue until the BAP receives a message to stop logging and/or until the BAP has insufficient memory available to continue logging usage data);
how many client devices 608 are accessing the BAP at each point in time;
what is the average number of client devices 608 accessing the BAP over a specified time period;
what is the peak number of client devices 608 accessing the BAP;
when are the peak number of client devices 608 accessing the BAP;
what is the lowest number of client devices 608 accessing the BAP;
which channels client devices 608 access;
when (e.g., the day/time) client devices 608 are accessing a given channel;
ranking of channel popularity at given time periods;
how long devices access the BAP (e.g. a total over a given period and/or for a given access session);
the frequency of channel changes;
when (e.g., the day/time) channel changes occur.

At state 602, the BAP transmits the client device usage tracking logging data to the BAP service provider system 604.

As similarly discussed above, should there be privacy concerns with respect to usage tracking for client devices optionally the BAP is configured so that the BAP will collect only statistical information and will not forward any client specific usage tracking data. Optionally, in certain embodiments, the BAP is configured to provide selected types of usage tracking data for a specific client device, but not in association with a client device or user identifier. Optionally, the BAP is configured to provide selected types of usage tracking data for a specific client device in association with a client device or user identifier (e.g., for usage tracking information that does not raise significant privacy concerns).

In certain instances, a BAP may be equipped with client functionality. For example, the BAP may include both access point/router functionality that can be utilized by other client devices to access broadcast services, such as television channels, and end-user client device functionality, such as a user interface, a display, and a speaker to enable a user to select content channels, and view and hear content. For use cases where a BAP is equipped with client functionality the BAP service provider can request (1) usage tracking data only for the routing functionality, (2) usage tracking data for only client functionality or (3) usage tracking data for both routing and client functions.

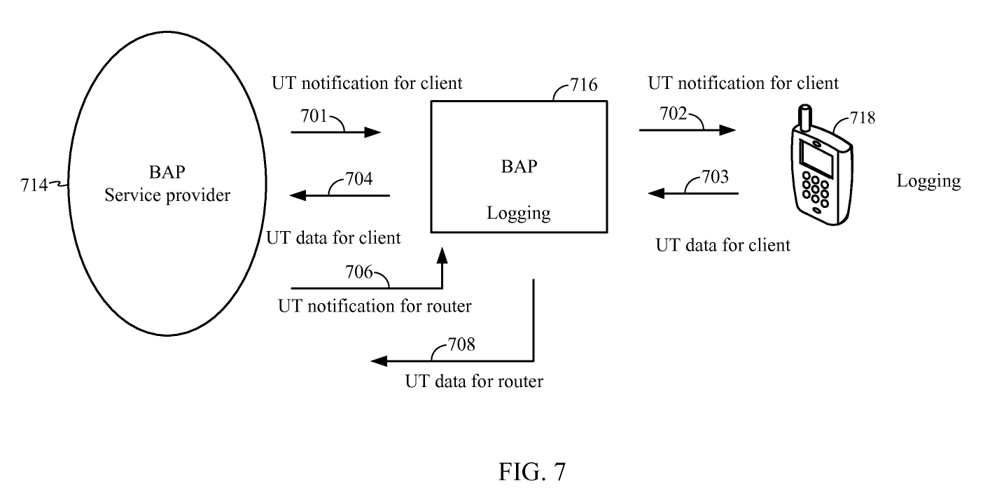

FIG. 7 illustrates an example BAP service provider managed usage tracking process with respect to both client devices and BAPs. This mode can be considered as the combination of the previous two modes. The BAP service provider system 714 can provide instructions for both the BAPs and client devices to collect various types of usage tracking data, optionally at substantially the same time. The BAP service provider system 714 can likewise collect usage tracking data from the BAPs 716 and client devices 718.

At state 701 a BAP service provider system 714 transmits a usage tracking notification to one or more BAPs 716. At state 702, the BAP 716 forwards the usage tracking notification from the BAP service provider 714 to a client device 718 hosting the logging application. At state 703, the client device 718 transmits the logged usage tracking data to the BAP 716 in response to a request from the BAP service provider system/BAP or in response to a reporting trigger. At state 704, the BAP 716 transmits the usage tracking data to the BAP service provider system 714. Optionally, the BAP 716 preprocesses the usage tracking data prior to transmitting the data to the BAP service provider system 714. For example, the BAP 716 may tabulate, aggregate, and/or statistically analyze usage data from a plurality of client devices prior to transmitting the tracking usage data to the BAP service provider system 714.

At state 706, the BAP service provider system 714 transmits a usage tracking notification to one or more BAPs 416, requesting the BAPs 416 to log various usage tracking data. At state 708, the BAP transmits the client device usage tracking logging data to the BAP service provider system 714. As discussed above, the logging data may be preprocessed by the BAP 718, and privacy of the client devices can be maintained with respect to the usage tracking data.

Of course, optionally for each of the above examples, usage tracking can be disabled.

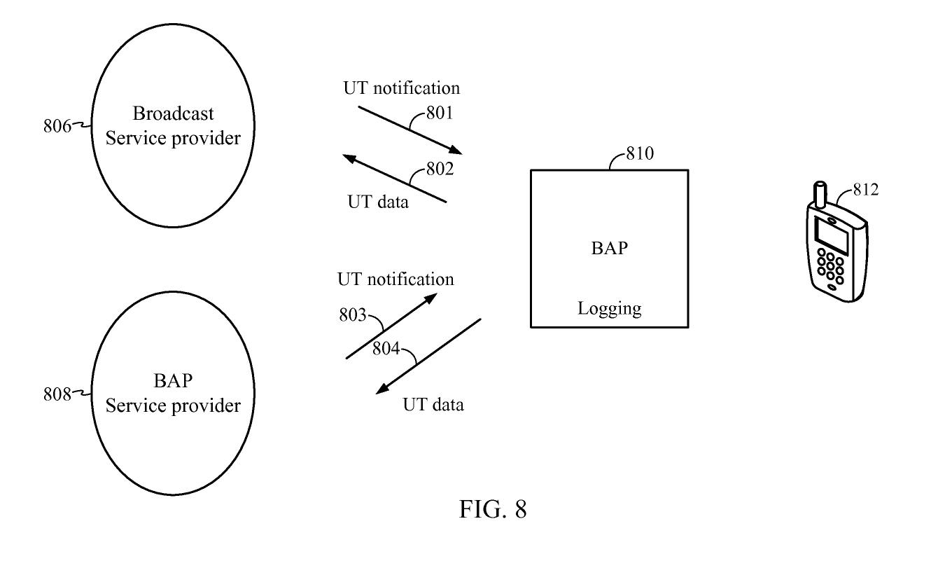

FIG. 8 illustrates a usage tracking service for BAP logging for both broadcast service providers and BAP service providers. Thus, a broadcast service provider and/or a BAP service provider can transmit usage tracking notifications to one or more of the same BAPs and can receive usage tracking log data from the BAPs.

Usage tracking service data collected by BAP and broadcast service providers can be shared, forwarded (optionally after performing preprocessing) and exchanged between the BSP(s) and broadcast service providers. For example, after the BAP service provider system collects usage tracking service data, filters or extracts data, the BSP service provider system optionally transmits such data to the broadcast service provider. Similarly, after the broadcast service provider system collects usage tracking service data, the broadcast service provider system filters or extracts data, and optionally transmits the data to the BAP service provider.

By way of example, the broadcast service provider may receive certain logged data from client devices related to movie channel viewing. The broadcast service provider can forward the log data to the BAP service provider. Optionally, the broadcast service provider system automatically filters out certain logged data prior to transmitting the logged data to the BAP service provider.

Referring to FIG. 8, at state 801, the broadcast service provider system 806 transmits a usage tracking notification to one or more BAPs 810, requesting the BAPs 810 to log various usage tracking data, including tracking data related to access of the BAP by client devices 812. The tracking notification can specify the data to be logged or can specify a logging profile to be used, where the logging profile has previously been stored on the one or more BAPs 810. At state 802, the BAPs 810 transmit the client device usage tracking logging data to the broadcast service provider system 806. For example, the usage tracking logging data can be transmitted via a broadcast network, a wired network, or other network to the broadcast service provider system 806.

In addition, another BAP service provider 808 similarly sends notification notices to all of the same BAPs 810 as does the BAP service provider 806. At state 803, the broadcast service provider system 806 transmits a usage tracking notification to one or more of the BAPs 810, requesting the BAPs 810 to log various usage tracking data, including tracking data related to access of the BAP by client devices 812. The tracking notification can specify the data to be logged or can specify a logging profile to be used, where the logging profile has previously been stored on the BAP 810. At state 804, the BAPs 810 transmit the client device usage tracking logging data to the broadcast service provider system 808. Thus, two different BAP service providers can provide their own logging instructions to, and can collect usage data from the same (or some of the same) BAPs.

Certain embodiments enable various entities or end-users to become on-site broadcasters of content (including customized channels and/or content) using one or more BAPs.

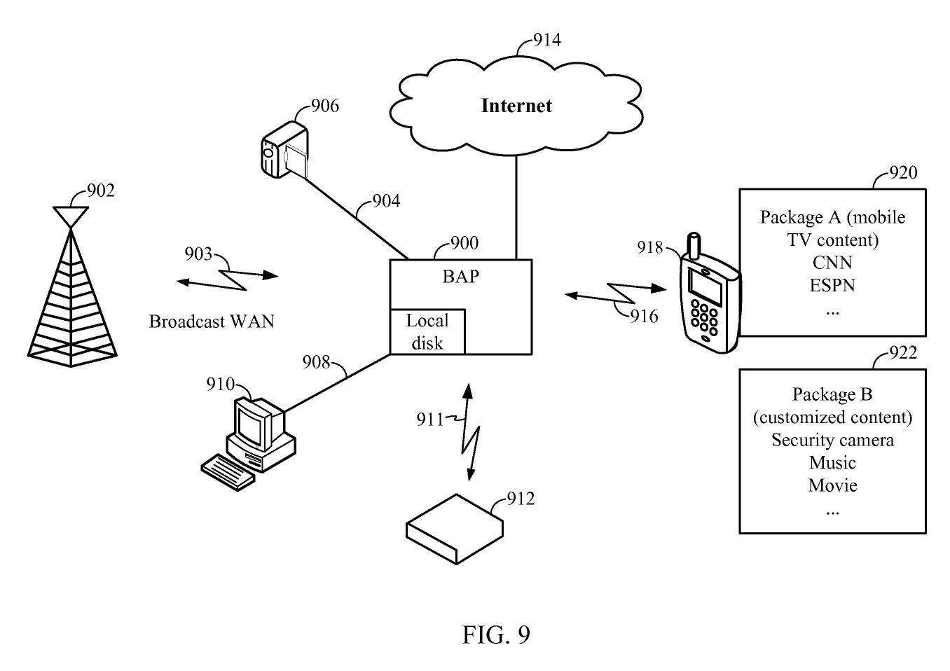

FIG. 9 depicts an example scenario for “micro” or localized broadcasting using a BAP router. The illustrated embodiment enables customized and/or location specific content to be broadcast via a BAP to one or more client devices. As will be discussed below, the BAP may be utilized for business/commercial use or for personal use.

The owner of the BAP in this example (owner in this context can mean the actual owner, the BAP operator, and/or other entity having permissions to specify content sources which the BAP is to access and clients/terminals to which the BAP is authorized to broadcast content), sets up the BAP to subscribe to a package “A” 920 (as illustrated in FIG. 9) from a mobile television (TV) service provider. Thus, upon requests from authorized client devices (which could be all client devices configured to communicate using a protocol compatible with the BAP, or which could be a subset of such clients, such as those associated with users that have subscription or account that entitles the client to access content via the BAP), the BAP will transmit mobile TV content associated with package “A” to the client devices. In addition or instead, the BAP may transmit certain content independent of a client device request (e.g., non-addressed content), and the user may tune to the BAP channel via the client device to view and/or watch the content.

In certain optional embodiments, the BAP device owner can create and/or specify packages/channels of customized content which optionally includes content from one or more sources in addition to or instead of content from mobile TV services. Thus, a given channel or channels can include content aggregated from multiple diverse sources. Optionally, the BAP may access and/or transmit some or all of the customized content over PAN/LAN networks, thereby reducing or eliminating the need for mobile TV system bandwidth for such customized content. For example, referring to FIG. 9, a package “B”, which provides customized content, is provided to authorized client devices.

To illustrate an example embodiment, a use scenario where a user creates a music channel will be described. A user interface is provided (e.g., via a Web page or otherwise) that can be accessed via a terminal (e.g., a general purpose computer, a phone, or otherwise) which enables the BAP owner or other authorized user to create a new channel/content package. The user interface optionally includes one or more of the following fields:
Channel name;
Program/content name;
Content location/locator (e.g., URL, file path name, etc.);
Broadcast time (to be used when there is set broadcast time);
Criteria for client device access.

For example, optionally the user may specify a channel name/identifier. The user can further specify one or more content sources for the channel. For example, the user and/or BAP owner can specify that the content is to be accessed from one or more of the following sources and/or other sources:
Local storage (e.g., nonvolatile hard disk drive, optical drive, solid state memory, etc.) of the BAP (e.g., installed in the same housing as the other portions of the BAP or in the substantially immediate proximity), wherein the content can be uploaded from external sources to the local storage;
Networked memory storage (e.g., nonvolatile hard disk drive, optical drive, solid state memory, etc., connected via a network, such as a wired or wireless local area network);
An external computer accessible via a network, such as a wired or wireless local area network;
Live images (still and/or video) from a camera (e.g., streamed from one or more cameras);
One or more Internet sources (e.g., specified via a Uniform Resource Locator);
One or more preexisting RF broadcast channels (e.g., broadcast radio and/or television channels).

Once the BAP is configured to receive content and broadcast one or more channels/programs, the BAP publishes its system information (e.g., its channel/program lineup) to client devices. Optionally, the client device is unaware of the original source of the content of each channel, that is, the client device is unaware from which source the BAP obtained the content (e.g., the client device does not know whether the content comes from a mobile TV broadcaster or elsewhere).

When a user, via a wireless client device, selects the channel from a mobile TV source, the BAP accesses/acquires the mobile TV channel and forwards the content by wirelessly transmitting the content to the client device (e.g., via a PAN/LAN).

If a user of the client device selects a customized channel, the BAP fetches the content from the source associated with the selected customized sources or tunes to the channel from the binding source. The BAP then forwards the content wirelessly to the client device.

Referring to FIG. 9, in the illustrated example, a BAP 900 optionally includes local mass storage that stores content. In addition, the BAP 900 may access content from a broadcast system (e.g., a mobile television broadcaster broadcasting to cell phones and other devices) over a wireless broadcast WAN 903. The BAP 902 may access live, streaming content from a camera 906 (which may be a still and/or video camera) over a wired or wireless network or peripheral bus (e.g., USB, Firewire, Bluetooth, etc.). The BAP 900 may access content from a remote memory storage device 912 via network 911, and from a remote computer 910 via network 908. In addition, the BAP 900 may access content (e.g., video clips, music, text, etc.) over the Internet (e.g., via one or more websites, file transfer protocol sites, or other source).

The content can then be accessed via one or more client devices 918 over a network 916 (e.g., a PAN or LAN network). The networks illustrated in FIG. 9 do not have to be separate networks, although optionally some or all are different networks. For example, network 908 and 911 may be the same network or they may be different networks.

The BAP owner may create channels for various content, such as that included in Package B 922. The channels can be set up to carry a certain type of content (e.g., music, prerecorded movies, prerecorded still images, live still images, live movies, broadcast RF radio station, broadcast RF radio station, Internet radio, Internet television, etc.) and/or the content may be selected based in whole or in part on the geographic location or the intended use of the BAP. By way of illustration, the BAP may be intended to route content for the owner's personal use or the BAP may be intended to route content for business or civic purposes (e.g., to customers or potential customers of a business or public venue).

For example, where the BAP is being used for the BAP owner's personal use, the BAP owner can set up one or more of the following channels:
Music (which may be the owner's music library or one or more favorite playlists stored on a local or remote disk or computer, or may be accessed from a third party Internet radio station, subscription service, or other source);
Movies/television shows (which may be the owner's movie/television library stored on a local or remote disk or computer, or may be accessed from a third party Internet movie/television station, subscription service, or other source);
Picture files (which may be the owner's photo library stored on a local or remote disk or computer, or may be accessed from a third party site, from a live camera, or other source);
Streaming video from a live security camera;
Special clips for celebrations (e.g., birthday, anniversary, other parties, etc.).

By way of example, when the BAP is utilized for a user's personal use, the BAP may be situated at a user's home, the user's car or other vehicle, or the user's office/place of business.

In addition to personal use in an owner's home/office/vehicle, the BAP may be utilized for commercial/civic purposes and/or may be located at various locales such as some or all of the following:
Office building
Museums
Amusement parks
Zoos
Aquariums
Stadiums
Shopping mall centers
Bus stations/stops
Commuter buses
Tour buses
Taxis
Trains
Retail shops
Movie theaters
Book stores
Toy stores
Coffee shops
Restaurants
Hospitals
Airplanes
Airports
and/or other venues/locations

Optionally, a BAP installed at a particular venue/location is configured to provide one or more channels of content that are relevant/related to the business and/or venue/location.

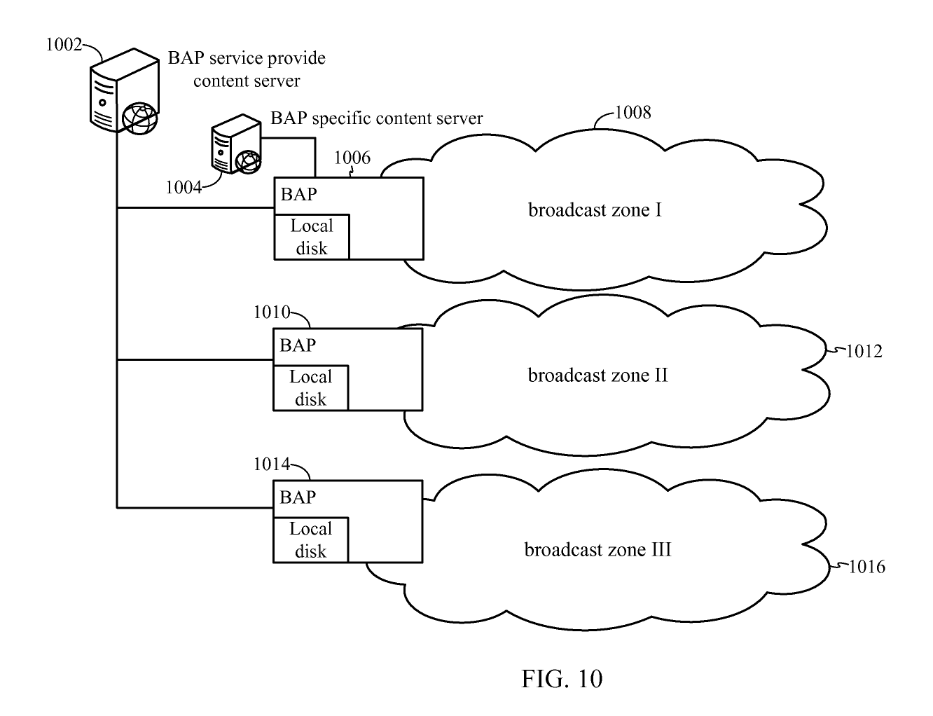

FIG. 10 depicts a use case where a BAP service provider (BSP) installs multiple BAPs 1004, 1010, 1014 at a particular venue with multiple sub-venues, in this example, a zoo. BAPs 1004, 1010, 1014 respectively provide broadcast zone I 1008, broadcast zone II 1012, and broadcast zone III 1016. Some or all of the BAPs 1004, 1010, 1014 receive some or all of their content from a BAP content server 1002 which provides common content to the BAPs 1004, 1010, 1014. Optionally, in addition to the common content, each BAP or some of the BAPs can have content specific to a given BAP or a subset of the BAPs that is particular relevant to the location of the given BAP. The specific content for a given BAP can be stored locally to the BAP or may be accessed via a network from the same content server system that stores the common content. For example, referring to FIG. 10, BAP 1006 is associated with a BAP specific content server that is not shared with other BAPs, and optionally stores and serves content that is not available to the other BAPs. In addition, the BAPs 1004, 1010, 1014 optionally each receive a different package of customized content from the BAP content server 1002, from which they also receive common content packages.

In this example, broadcast zone I 1008 provides coverage for the reptile exhibit and broadcast zone II 1012 provides coverage for the African animal exhibit. Broadcast zone I 1008 offers customized content related to reptiles (e.g., documentaries on reptiles, including documentaries on reptiles being exhibited, sound tracks of reptiles, photographs of the reptiles on exhibit, streaming video of the reptiles on exhibit, encyclopedia entries on reptiles, etc.). Broadcast zone II 1012 offers content related to African animals. (e.g., documentaries on African animals, including on African animals being exhibited, sound tracks of African animals, photographs of the African animals on exhibit, encyclopedia entries on African animals, streaming video of the African animals on exhibit, etc.).

Multiple sources can be associated with a given customized or site specific channel (e.g., a remote networked content server and local mass storage). When multiple sources are associated with a given channel, an operator can set a priority configuration indicating which content has priority over others. The priority may be set via a user interface provided for display on an operator terminal. The priority may be set in terms of bandwidth, with respect to a type of client request received via the BAP, with respect to which client is making the request, or otherwise. For example, a first type of content (e.g., audio) that is more sensitive to interruptions may be allocated all the bandwidth that is needed, and the remaining bandwidth is divided (equally or otherwise) among other content. By way of further example, client requests for show times may be given priority over requests for an encyclopedia entry. By way of still further example, requests for content from users with a yearly pass may be given priority over requests from users who have purchased a one day pass.

Optionally, the system (e.g., via the BAP being accessed or via a remote computer system) will generate and/or dynamically modify/customize a media presentation guide, including channel and program listings, which will be downloaded to the appropriate client devices.

Content from external sources can be transmitted to a client upon a client request, or the content may be pushed to the client (e.g., streamed or otherwise transmitted to the client based on a predetermined schedule or in response to a given event) even in the absence of the client device request.

As discussed above, a BAP service provider can support not only diverse business entities (e.g., zoos, museums, stadiums, retail establishments, transportation companies) but also an individual end-user. For example, the BAP service provider may provide for display on a user terminal a user interface via which a user may configure one or more channels, specify the type of content to be provided via a given channel, specify schedules on which specific content is to be transmitted, specify areas/subjects of interest (e.g., interested in sports, a specific entertainer, local news, national news, movies, etc.) and/or specify a source of some or all of the content. The content may then be broadcast to the individual end user's terminal (e.g., phone or other device) via geographically distributed BAPs in accordance with the user specified configuration.

As previously discussed, content accessible via a BAP can be customized based on the locality of the BAP. Instead or in addition, channels can be customized and/or and channel content scheduled, based in whole or in part on the characteristics of a given BAP and/or based on user preferences/characteristics. For example, a BAP service provider (BSP) can create a customized channel and/or schedule content for the channel for a BAP and/or user clients based on their corresponding profiles and feedback.

Various techniques are optionally used to gather BAP/user profiles and/or feedback. An example technique utilizes the usage tracking process performed at the client devices and/or BAPs, as discussed above. In addition or instead, users may send explicit feedback information to the BSP.

For example, the usage tracking service described above may be utilized to obtain an aggregated preference of users of a given BAP. By way of illustration, the BAP can track and report to the BSP system how many devices have been accessing a given type of content (e.g., movies on movie channels) from a given source or source type (e.g., a mobile television service), over a period of time (e.g., the previous week). Optionally, the tracking service may also report to the BSP system the specific content (e.g., the name of the movies) that has been accessed and/or the movie genre (comedy, drama, action, horror, mystery, romance, etc.). If it appears from the tracking information that movies are being accessed with great frequency (e.g., where the number of movies/time period is greater than a specified threshold, the BSP (manually or automatically via the BSP system) may elect to create a customized movie channel for the BAP.

Optionally, the movies selected for the customized channels may be selected based on the types of movies that have previously been accessed via the BAP. The BSP may configure the customized channel via a user interface, wherein the authorized client devices can then access the new customized movie channel.

By way of further example, the BSP can create and define various channels for different purposes and targets, such as the following channel-types:
A BAP-level channel, where a customized channel is created for a given BAP. Authorized devices accessing the BAP can then access the customized channel.
A Client-level channel customized for a particular user and/or client device. When a client device connects to the BAP, the user is identified via log in or other identification information provided via the client device. The channel data for the user is retrieved at the BSP's server (or other designated storage system). The server transmits customized system information to the BAP, which relays the information to the client device. For example, the customized system information may include a media presentation guide, such as that discussed above, which lists the available channels and content and optionally content/program broadcast schedules. As previously discussed, the media presentation guide can be customized and include content aggregated from different sources (including live sources, such as from a video camera, and pre-recorded media), using different networks, and different storage systems.
The customized channel information can be transmitted to the client via the BSP system, which then transmits the customized channel information via a PAN/LAN to the client (with the optional benefit of reducing the load on the broadcast bandwidth). Optionally, instead or in addition, the customized content is transmitted via a broadcast network. If the client selects the channel, the BAP fetches the content from the content server and transmits the content via the PAN/LAN to the client.
A channel customized for a type of user/client. For example, the BSP can classify users/clients into one or more categories, (e.g., movie watchers, sport fans, news fans, reality show fans, situation comedy fans, concert fans, etc.). Different channels can be customized for each client, where the channel content corresponds to the preferred content of that category (e.g., sports content for sports fans). When a user logs into the system via the user's client device (which transmits an identifier associated with the user to the BAP), the BAP accesses the user's profile corresponding to the user identifier, retrieves the category information from the user's profile, and fetches the customized system information (e.g., media presentation guide) and content for that category and transmits them to the user's client device.
A channel customized for a group of users/clients. For example, users of the clients may form a specific group by requesting admission to a group (e.g., a social networking group) or by receiving an invitation to join the group. By way of further example, the group may have been formed via a social networking site (which may optionally be associated with the BSP) or otherwise. By way of illustration, users may form a group based on a common interest (e.g., in a specific sports team, in a specific sport, in a specific celebrity, in a specific show, etc.). The BAP and/or BSP system may track the group members usage (e.g., the content they access, the frequency they access the content, when they access the content, etc.) and may examine such tracking information to implicitly learn the group's preferences.
In addition or instead, group members may explicitly indicate their interests and preferences. For example, a group member may access a user interface via their client device or other device (e.g., a desktop computer), identify which group they belong to, and identify the types of content the group member is interested in. By way of further example, the group member can use “voting” controls on the client device, and when a piece of content is being played on the group member's client device, the group member can vote that the group member likes the content or that the group member does not like the content. Based on this information, the BSP generates a customized channel for the group. When a user logs into the system via the user's client device (which transmits an identifier associated with the user to the BAB), the BAP accesses the user's profile corresponding to the user identifier, determines which group the user is a member of from the user's profile, and fetches the customized system information (e.g., a media presentation guide) and content for that group and transmits them to the user's client device.

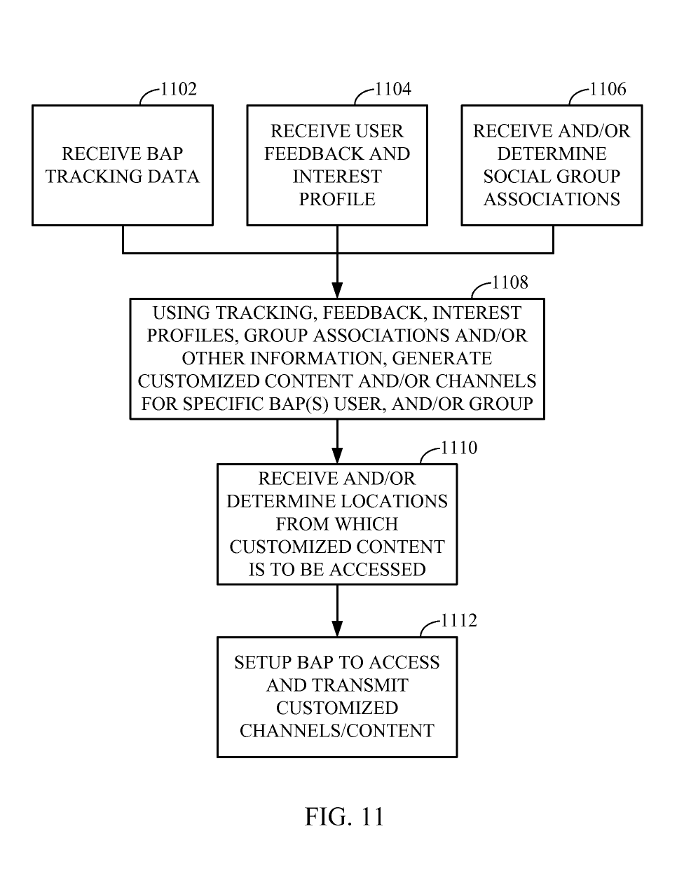

FIG. 11 illustrates an example process for gathering data used to select content for a customized channel. At state 1102, BAP tracking data is received at a system (e.g., a content planner system which may be associated with a BAP service provider or broadcast provider, by way of example) from one or more BAPS, and the system stores the same in memory. At state 1104, user feedback regarding content and user interest profiles (e.g., where a user specified the types and/or specific content the user is interested in) are received at the system, and the system stores the same in memory. At state 1106, group associations are received, indicating members of a given group and a group interest profile (which specifies the types and/or specific content the user is interested in) at the system, and the system stores the same in memory.

At state 1108, via an automated system and/or manually, some or all of the data is used to define one or more customized content channels. Optionally, the channels are dynamically customized in substantially real-time. Optionally, the system correspondingly dynamically generates a media presentation guide in substantially real time. At state 1110, the system receives via an interface location information (e.g., URL, pathnames, etc) identifying where content for the customized channel is to be accessed from, and/or the system determines such location information.

At state 1112, the system or another system or operator sets up one or more BAPs to receive and transmit such customized channels and content (e.g., by providing content location information, timing, criteria for determining which client devices can access which channels, and/or other settings). Optionally, a remote server, such as that associated with the BAP service provider, stores the content location information, timing, criteria for determining which client devices can access which channels, and the BAP routes requests from client devices received via the BAP's PAN/LAN interface, to the server. The server then accesses and transmits the requested content to the BAP, which can in turn relay the content to the client device. In such an embodiment, optionally the BAP does not store location information for each piece of content or content scheduling information. Further, in such an embodiment, the remote server may generate the media presentation guide, transmit the media presentation guide to the BAP, which then relays the guide to the client device.

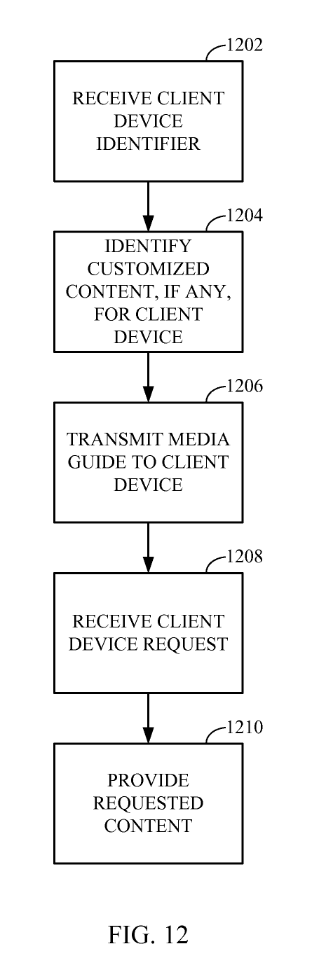

FIG. 12 illustrates an example process of transmitting customized content to a user client device. At state 1202, a BAP receives a client device identifier, which may uniquely identify the client device and/or the user of the client device. The identifier can be in the form of a user ID provided during a login session, a code stored in a file on the client device and accessed by the BAP, an identifier provided in a packet header, or otherwise. At state 1204, the BAP determines if the client device is to be provided with customized content, such as in the form of a customized content channel, using the client device identifier. The BAP may obtain this information from a local database that stores identifiers in association with an indication that the holder of the identifier is to be provided with the customized content. In addition or alternatively, the BAP may obtain this information from a remote database or system, such as a BSP system database.

At state 1206, the BAP transmits an appropriate, optionally customized media guide to the client device. The media guide may be generated by the BAP or the media guide may be accessed by the BAP from another system (e.g., a remote BAP service provider server). For example, the media guide may be in the form of the media presentation guide (MPG) described above, which provides a listing of available channels, including customized channels and optionally a broadcast schedule of shows including show timing. The media guide may be transmitted to the client device in response to a request from the client device, or the media guide may be pushed to the client device.

At state 1208, the BAP receives a request for content, which may be in the form of a channel request (e.g., a customized channel) or a request for specific content (e.g., a customized program) from the client device. At state 1210, the requested content is transmitted to the client device (e.g., as a file or streamed to the client device by the BAP). Optionally instead, the client device may tune into the customized content that is already being broadcast, rather then transmitting a request for content.

In an example embodiment, a BAP does not broadcast content until a request is received from a client device. When a first client device connects to the BAP, the BAP transmits a media guide to the first client device. The first client device user can then select a first content from the media guide. The first client device transmits a request for the first content to the BAP, which then accesses the requested first content (e.g., from local memory, a remote server, a broadcast, a video camera, etc.), and transmits a port to the first client device for the first content and transmits the first content via a PAN/LAN. The requesting first client device can then access the first content.

If a second client device then connects to the BAP while the selected first content is being transmitted to the first client device, the BAP optionally transmits a media guide to the second client device, wherein the media guide is configured to indicate that the first content is currently being transmitted and available to the second client device. If the second client device user selects the first content, the same port as was transmitted to the first client device is transmitted to the second client device. Then the second client device will access the first content at the same time as the first client device using the same port, without the BAP having to initiate a separate transmission of the first content to the second client device. Thus, optionally, content can be transmitted using a hybrid of on-demand and “scheduled” techniques, where the first content is initially provided to the first user in response to the first user request, but then other users can tune in to the ongoing transmission of the first content.

Optionally, instead, the BAP will initiate a new transmission of the first content to the second client device in response to the second client device user selection, where the first content will be played from the beginning.

Optionally, if transmission of the first content to the first client device has begun and is continuing, and a request for the same content is received from the second client device, the BAP automatically determines bandwidth and/or PAN/LAN transceiver availability. If there is sufficient bandwidth and/or PAN/LAN transceiver availability (e.g., equal to or greater than a specified threshold stored in memory or calculated by the BAP), the BAP will initiate a new transmission of the first content to the second client device, from the start of the first content. This enables the user of the second client device to watch the first content from the beginning. However, if the BAP determines that there is insufficient bandwidth and/or PAN/LAN transceiver availability (e.g., below a specified threshold stored in memory or calculated by the BAP), the BAP will not initiate a new transmission of the first content to the second client device. Instead, the second client device will access the first content already being transmitted at the same point as the first client device is currently accessing the first content.

In order to reduce unneeded transmission of content (e.g., to reduce power consumption and bandwidth utilization), the BAP may periodically ping client devices after transmission of content to the client devices has begun. If no response is received from any client device that had requested the content (e.g., indicating that the client devices are no longer within range of the BAP PAN/LAN or that the client devices have been turned off), then the BAP optionally will cease transmission of such content.

Thus, as described above, certain embodiments wirelessly provide common and/or customized content to user terminals in a cost effective manner without requiring an expensive transmitted deployment and without consuming wireless, cellular phone broadcast capacity and bandwidth. Further, certain embodiments include BAPs that provide a local broadcast area via PAN/LAN technologies, where the local broadcast area is much smaller in geographical size than that provided by many conventional approaches. Certain embodiments are scalable in size and support diverse use cases ranging from individual end-users, to very large venues.

In one or more example embodiments, the functions, methods, algorithms, and techniques described herein may be implemented in hardware, software, firmware (e.g., including code segments), or any combination thereof. If implemented in software, the functions may be stored on or transmitted over as one or more instructions or code on a computer-readable medium. Tables, data structures, formulas, and so forth may be stored on a computer-readable medium. Computer-readable media include both computer storage media and communication media including any medium that facilitates transfer of a computer program from one place to another. A storage medium may be any available medium that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. For a hardware implementation, one or more processing units at a transmitter and/or a receiver may be implemented within one or more computing devices including, but not limited to, application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof

For a software implementation, the techniques described herein may be implemented with code segments (e.g., modules) that perform the functions described herein. The software codes may be stored in memory units and executed by processors. The memory unit may be implemented within the processor or external to the processor, in which case it can be communicatively coupled to the processor via various means as is known in the art. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Although certain embodiments and examples are discussed herein, it is understood that the inventive subject matter extends beyond the specifically disclosed embodiments and examples to other alternative embodiments and uses and to obvious modifications and equivalents thereof. Thus, it is intended that the scope of the disclosure should not be limited by the particular disclosed embodiments and examples. For example, in any method or process disclosed herein, the acts, steps, or operations making up the method/process may be performed in any suitable sequence and are not necessarily limited to any particular disclosed sequence. Also, acts, steps, or operations may be added, removed, combined, or rearranged in other method/process embodiments. In systems and devices disclosed herein, components may be added, removed, combined, and/or arranged differently than described herein.

Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein. Further, embodiments may include several novel features, no single one of which is solely responsible for the embodiment's desirable attributes or which is essential to practicing the systems, devices, methods, and techniques described herein.

What is claimed is:

1. A localized broadcasting system, comprising:
a first broadcast access point, the first broadcast access point including:
a processor;
a wide area broadcast network interface coupled to the processor;
a wireless local area network interface and/or wireless personal area network interface coupled to the processor;
a usage logging module configured to:
receive a usage logging notification from a remote system; and
at least partly in response to the usage logging notification from the remote system, log usage data with respect to content provided by the first broadcast access point to one or more client devices that access content from the first broadcast access point via the wireless local area network interface and/or the wireless personal area network interface;
transmit usage information to the remote system, wherein the usage information includes at least a portion of and/or is derived from the usage data;
the remote system, wherein the remote system is configured to receive the usage information, wherein the usage information is to configured to be utilized to specify a customized content channel to be provided to at least one client device and/or a user thereof;
wherein the first broadcast access point is further configured to:
transmit a media guide via the wireless local area network and/or wireless personal area network interface to a first client device, wherein the media guide includes an identification of content provided via the customized content channel; and
transmit content associated with the customized content channel to the first client device via the wireless local area network interface and/or wireless personal area network interface.

2. The system as defined in claim 1, further comprising a second broadcast access point operated by the same entity as the first broadcast access point and geographically remote from the first broadcast access point, wherein the second broadcast access point is configured to access at least partly different content than the first broadcast access point, the at least partly different content associated with a second customized channel, and to transmit the at least partly different content to one or more client devices.

3. The system as defined in claim 1, wherein the first broadcast access point is further configured to filter information identifying a specific client device from being included in the usage information before the usage information is transmitted to the remote system.

4. The system as defined in claim 1, wherein the first client device is a wireless telephonic device.

5. The system as defined in claim 1, wherein the customized channel includes content aggregated from a plurality of different sources.

6. The system as defined in claim 5, wherein the different sources include at least a site accessed over the Internet and a video camera transmitting real time video accessible by the first broadcast access point.

7. The system as defined in claim 1, wherein the first broadcast access point is configured to determine what usage information is to be logged from instructions included in the usage logging notification.

8. The system as defined in claim 1, wherein the customized content channel is selected based in part on preference information provided by a user of at least one client device.

9. The system as defined in claim 1, wherein the customized content channel is specified based in part on a membership of a user of at least one client device in a social group having an interest in a first common subject.

10. The system as defined in claim 1, wherein the usage information includes information on:
how many client devices have accessed content the first broadcast access point over a first period of time;
which channels have been accessed by client devices; and
how often a given channel has been accessed by client devices.

11. The system as defined in claim 1, wherein the first broadcast access point is configured to:
receive at the first broadcast access point a request from a first client device for a first item of content;
transmit the requested first item of content over the wireless local area network interface and/or the wireless personal area network to the first client device;
receive at the first broadcast access point a request from a second client device for the first item of content while the transmission of the first item of content to the first client device is in progress;
determine if resources are available to initiate a transmission, separate from the transmission to the first client device, of the first item of content to the second client device so that the user of the second client device can access the first content from the first content's beginning;
at least partly in response to determining resources are available to initiate a transmission, separate from the transmission to the first client device, of the first item of content to the second client device, initiating such transmission from the first broadcast access point to the second client device; and
at least partly in response to determining resources are not available to initiate a transmission, separate from the transmission to the first client device, of the first item of content to the second client device, causing, at least in part, the second client device to access the in-progress transmission of the first item of content to the first client device.

12. A computer program product, comprising:
a computer-readable medium comprising:
code operable to cause a computer to:
transmit a usage logging notification to a first broadcast access point over a wide area broadcast network, the usage logging notification instructing the first broadcast access point to collect usage information related to the usage of the first broadcast access point by client devices and/or of content provided by the first broadcast access point to client devices, wherein the first broadcast access point is configured to provide the content to the client devices via a wireless local area network interface and/or wireless personal area network interface;
receive usage information from the first broadcast access point, the usage information related to the usage of the first broadcast access point by client devices and/or content provided by the first broadcast access point to client devices; and
store a customized channel definition, the customized channel definition generated at least in part based on the received usage information.

13. The product of claim 12, wherein the code is further operable to cause a computer to:
transmit a media guide to the first broadcast access point wherein the media guide includes an identification of content provided via the customized content channel.

14. The product of claim 12, wherein the code is further operable to cause a computer to:
transmit a second usage logging notification to a second broadcast access point, the second usage logging notification instructing the second broadcast access point to collect usage data related to the usage of services provided by the second broadcast access point to client devices;
receive from the second broadcast access point usage information related to the usage data logged by the second broadcast access point; and
store a second customized channel definition generated at least in part based on the received second broadcast access point usage information, wherein the second customized channel definition is different then the channel definition based on the usage information from the first broadcast accesses point.

15. The product of claim 12, wherein the usage information received from the first broadcast access point has been filtered by the first broadcast access point to remove identification information identifying a specific client device.

16. The product of claim 12, wherein the first client device is a wireless telephonic device.

17. The product of claim 12, wherein the customized channel includes content aggregated from a plurality of different sources.

18. The product of claim 17, wherein the different sources include at least a site accessed over the Internet and a video camera transmitting real time video accessible by the first broadcast access point.

19. The product of claim 12, wherein the customized content channel is specified in part based on preference information provided by a user of at least one client device.

20. The product of claim 12, wherein the customized content channel is specified based in part on a membership of a user of at least one client device in a social group having an interest in a first common subject.

21. The product of claim 12, wherein the usage information includes information on:
how many client devices have accessed the first broadcast access point;
which channels have been accessed by client devices; and
how often a given channel has been accessed by client devices.

22. A computer implemented method for distributing customized content, the method comprising:
transmitting a usage logging notification to a first broadcast access point over a wide area broadcast network, the usage logging notification instructing the first broadcast access point to collect usage information related to the usage of the first broadcast access point by client devices and/or of content provided by the first broadcast access point to client devices, wherein the first broadcast access point is configured to provide the content to the client devices via a wireless local area network interface and/or wireless personal area network interface; and
receiving usage information from the first broadcast access point, the usage information related to the usage of the first broadcast access point by client devices and/or content provided by the first broadcast access point to client devices;
storing a customized channel definition, the customized channel definition generated at least in part based on the received usage information.

23. The method of claim 22, the method further comprising:
transmitting a media guide to the first broadcast access point wherein the media guide includes an identification of content provided via the customized content channel.

24. The method of claim 22, the method further comprising:
transmitting a second usage logging notification to a second broadcast access point, the second usage logging notification instructing the second broadcast access point to collect usage data related to the usage of services provided by the second broadcast access point to client devices;
receiving from the second broadcast access point usage information related to the usage data logged by the second broadcast access point; and
storing a second customized channel definition generated at least in part based on the received second broadcast access point usage information, wherein the second customized channel definition is different then the channel definition based on the usage information from the first broadcast accesses point.

25. The method of claim 22, wherein the usage information received from the first broadcast access point has been filtered by the first broadcast access point to remove identification information identifying a specific client device.

26. The method of claim 22, wherein the first client device is a wireless telephonic device.

27. The method of claim 22, wherein the customized channel includes content aggregated from a plurality of different sources.

28. The method of claim 27, wherein the different sources include at least a site accessed over the Internet and a video camera transmitting real time video accessible by the first broadcast access point.

29. The method of claim 22, wherein the customized content channel is specified in part based on preference information provided by a user of at least one client device.

30. The method of claim 22, wherein the customized content channel is specified based in part on a membership of a user of at least one client device in a social group having an interest in a first common subject.

31. The method of claim 22, wherein the usage information includes information on:
how many client devices have accessed the first broadcast access point;
which channels have been accessed by client devices; and
how often a given channel has been accessed by client devices.

32. An apparatus for distributing content, the apparatus comprising:
means for transmitting a usage logging notification to a first broadcast access point over a wide area broadcast network, the usage logging notification instructing the first broadcast access point to collect usage information related to the usage of the first broadcast access point by client devices and/or of content provided by the first broadcast access point to client devices, wherein the first broadcast access point is configured to provide the content to the client devices via a wireless local area network interface and/or wireless personal area network interface; and
means for receiving usage information from the first broadcast access point, the usage information related to the usage of the first broadcast access point by client devices and/or content provided by the first broadcast access point to client devices;
means for storing a customized channel definition, the customized channel definition generated at least in part based on the received usage information.

33. The apparatus of claim 32, the apparatus further comprising:
means for transmitting a media guide to the first broadcast access point wherein the media guide includes an identification of content provided via the content channel.

34. The apparatus of claim 32, the apparatus further comprising:
means for transmitting a second usage logging notification to a second broadcast access point, the second usage logging notification instructing the second broadcast access point to collect usage data related to the usage of services provided by the second broadcast access point to client devices;
means for receiving from the second broadcast access point usage information related to the usage data logged by the second broadcast access point; and
means for storing a second customized channel definition generated at least in part based on the received second broadcast access point usage information, wherein the second customized channel definition is different then the channel definition based on the usage information from the first broadcast accesses point.

35. The apparatus of claim 32, wherein the usage information received from the first broadcast access point has been filtered by the first broadcast access point to remove identification information identifying a specific client device.

36. The apparatus of claim 32, wherein the first client device is a wireless telephonic device.

37. The apparatus of claim 32, wherein the customized channel includes content aggregated from a plurality of different sources.

38. The apparatus of claim 37, wherein the different sources include at least a site accessed over the Internet and a video camera transmitting real time video accessible by the first broadcast access point.

39. The apparatus of claim 32, wherein the customized content channel is specified in part based on preference information provided by a user of at least one client device.

40. The apparatus of claim 32, wherein the customized content channel is specified based in part on a membership of a user of at least one client device in a social group having an interest in a first common subject.

41. The apparatus of claim 32, wherein the usage information includes information on:
how many client devices have accessed the first broadcast access point;
which channels have been accessed by client devices; and
how often a given channel has been accessed by client devices.
